(19) United States
(12) Patent Application Publication
(10) Pub. No.: US 2016/0335254 A1
(43) Pub. Date: Nov. 17, 2016

(54) Machine Translation System and Method

(71) Applicant: Alibek ISSAEV, Dubai (AE)

(72) Inventor: Alibek ISSAEV, Dubai (AE)

(21) Appl. No.: 15/159,330

(22) Filed: May 19, 2016

Related U.S. Application Data
(63) Continuation of application No. 14/673,268, filed on Mar. 30, 2015, now abandoned.

(51) Int. Cl. G06F 17/28; G06F 17/27

(52) U.S. Cl. CPC G06F 17/289; G06F 17/277

(57) ABSTRACT

A machine or computer translation system and method which translates texts (conveying their meanings) from one natural language to another. The system and method have a modular structure for organizing languages, which in combination with a transitory (indirect) method of translation allows for the creation of a multilingual system that is capable of translations in any direction between any of the included languages. Every linguistic module includes a dictionary of words and phrases, a list of operational functions, and parameters that guide the conversion processes needed to perform a translation from one language to another. The system further utilizes an algorithm designed for a rule-based machine translation.

### CROSS REFERENCE

The present application is a continuation application of non-provisional application Ser. No. 14/673,268 filed on Mar. 30, 2015, which claims the priority benefit of U.S. Provisional Application No. 61/971,764 filed on Mar. 28, 2014, the contents of which are hereby incorporated by reference in their entirety.

### FIELD OF THE INVENTION

The present invention relates generally to the field of machine or computer based translation systems and methods, and more particularly to a machine or computer translation system and method that performs translation of written text from one natural language into another using a modular organization of languages, together with a transit process of translation. This provides creation of a multilingual system with the ability to translate in all directions between all integrated languages. As used herein, “translation” is intended to mean a conversion of the meaning of an expression or word in one language to the same meaning in another language.

### BACKGROUND

Various types and configurations of computer based translation systems and methods have been known in the art. These prior art systems and methods have lacked versatility and speed. Some prior systems and/or methods have relied on a character recognition process which slows down the analysis.

### SUMMARY OF THE INVENTION

As noted above, the present invention (sometimes hereinafter referred to as the “MTS”) uses a system and method that have a modular organization of languages, together with the transit method of translation. Each language module includes dictionaries, service lists and rules, which control necessary conversions of text during translation from one language into another. The transit method of translation is an option of using a transit language or multiple languages during translation between languages. For transit languages there is no morphological synthesis, and a fully analyzed (tagged) sentence is used for further translation.

There are three basic stages in the process of translation by means of the MTS, the “present invention”. These include: (i) an analysis of source text; (ii) the translation itself; and (iii) the synthesis of the translated text.

Analysis of the source text results in an unambiguous identification of all parts of speech and dependencies between words. (dependencies as a rule, are a set of grammatical relations between two words within a sentence).

At the translation itself stage, word meanings are translated into another language, words change their position in accordance with the target grammar, and dependencies get transformed as well.

During the synthesis stage, final modification is made. These include replacement and insertion of service words, and adjustment of endings.

Each of the listed stages utilizes rules of text transformation, which are consolidated into grammars.

Synthesis results in a fully tagged structure of a sentence. This is why such a sentence can be easily translated into any other language without having to run analysis. Transit translation is based on this principle.

The foregoing summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWINGS

Having described embodiments of the invention in general terms, reference will now be made to the accompanying drawings, in which:

FIG. 1(a) is a representative schematic diagram illustrating the method of the invention;

FIG. 1(b) is a representative schematic diagram illustrating the system of the invention;

FIG. 2 is a flow chart of the translation process of the present invention;

FIG. 3 is a schematic representation of a lexeme used in the invention;

FIG. 4 is a diagram illustrating an example of dependencies in a sentence (English language);

FIG. 5 is a flow chart illustrating the operation and sequence of Rules used in the present invention;

FIG. 6 is a schematic representation of the operation of Rules in grammar;

FIG. 7 is a flow chart illustrating the basic steps of the functional algorithm of the present invention;

FIG. 8 is a flow diagram illustrating the text translation sequence of the present invention;

FIG. 9 is a flow chart illustrating an example of translating the sentence “I go to the USA on Jan. 1, 2014.” into Russian;

FIG. 10 is a flow chart illustrating indirect (transitive) translation from a language A to a language C; and

FIG. 11 is a flow chart illustrating indirect (transitive) translation from a language A to a language D.

### DESCRIPTION OF EXEMPLARY EMBODIMENTS

Structural elements of the system include:

(i) Lexical units (corresponds to the set of word forms for a given word).

(ii) Attributes (determine parts of speech and their possible properties and characteristics).

(iii) Formats (represent a sequence of attributes, which can be used to describe positions of endings and more).

(iv) Dependencies (determine relations between two words in a sentence).

(v) Grammars (serve to transform linguistic information and consist of lists of rules).

Structural elements of the system are controlled by rules (written on an internal programming language of the MTS). Rules are used for correct translation of each token, sentence, or a paragraph from source language into a target language.

A token is an element that represents a sequence of symbols, grouped by predefined characteristics (for example, an identifier, a number, a punctuation mark, date, word, etc.). Tokens within a sentence are separated by a space. This way all of the elements that are located between spaces are identified by the system as separate tokens.

This MTS includes a machine translation algorithm that is based on grammar and rules. Grammar is a functional block that transforms linguistic information and consists of a list of rules, which are performed consecutively, from top to bottom. Grammar rules, in turn, consist of a sequence of operators.

Grammars work with incoming linguistic information, i.e. with a preprocessed sentence, split into tokens with defined initial attributes that are obtained from the orthographical dictionary. Grammar has input parameters, through which information is received. Real values of parameters are sent to grammar input. These values are stored in a current list, which is an internal buffer for storing results of intermediate modifications.

Operators can produce changes in current lists. These include change, add or remove words (tokens), remove word variations, add or remove attributes and dependencies. These changes of current lists are made on sentence images and are transferred to the sentence itself only if the main grammar is triggered. If the grammar did not trigger, the image of sentence with changes is deleted and the initial sentence remains in the form it was after last being processed by grammar.

After the main grammar is triggered, all changes in the sentence become irreversible.

Grammars are split into three groups: the grammar of (i) analysis, (ii) translation; and (iii) synthesis. There are also operational grammars, i.e., grammars of: (i) Service; (ii) Dictionary; and (ii) Assistant.

Execution of main group grammars is initiated by the system. Operational grammars are used by the system and can also be called from the rules of main grammars and translation dictionaries.

For each language there is a dedicated orthographical dictionary. This is a dictionary that contains words with all distinctive attributes. The dictionary is structured in families with indication of all possible variations of use of a word (but without translation).

Translation of words and phrases is contained in a translation dictionary. This dictionary consists of consecutive entries, which contain word-by-word translation (one lexical unit after another), from one language into another. The translation dictionary also includes translations of phrases. The mechanics of phrases used within the MTS allows transforming the meaning of a phrase and grammatical dependencies between words from one language into another.

Translation dictionary operates with special parameterized phrases, which enables formation of translation patterns for a wide array of similar sentences. Each parameter corresponds to a dedicated grammar, which checks the correctness of word or word combination placement into a given phrase.

Placement parameters in phrases can be filtered by means of additional conditions, which are set by attributes. Attributes can also be added to a phrase, if the goal is to have correct processing of all word forms of a given word. If the goal is to have the phrase work in a wider context, then parameters will check for specific value use. This way the number of phrases that would fit a given pattern would increase.

Some phrases are set with detailing grammars (form the list of operational grammars or dictionary grammars), which allows to avoid various errors, for example those related to the written form of a word in different registers or the use of articles.

There is also another group of phrases—contextual phrases. Here, the possible context of a sentence is considered and the translation of a word depends on the surrounding context.

Any word that is absent in the orthographical dictionary can be obtained during the process of word formation. This method of processing is applied for complex words and words with prefixes and postfixes. Besides, during processing, words in the dictionary can be split into parts if needed.

Collaborative process of creating, editing and managing a machine translation system is ensured and organized by a special information system, a Linguistic Support System, (or “LSS”). LSS is a server solution with a dialog web-interface that can be accessed via a browser. It allows linguists and translators to monitor the translation process, edit dictionaries, add translations of language pairs and ensure learnability of the system. LSS features a user-friendly interface, where all linguistic instruments are organized in groups.

This way the described MTS has all of the tools required for a high quality and correct translation of text from one language into another.

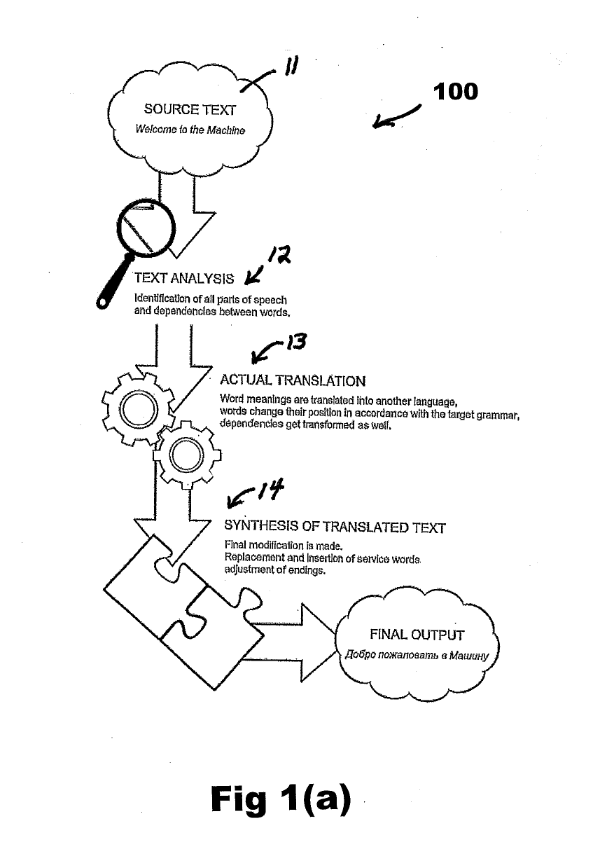

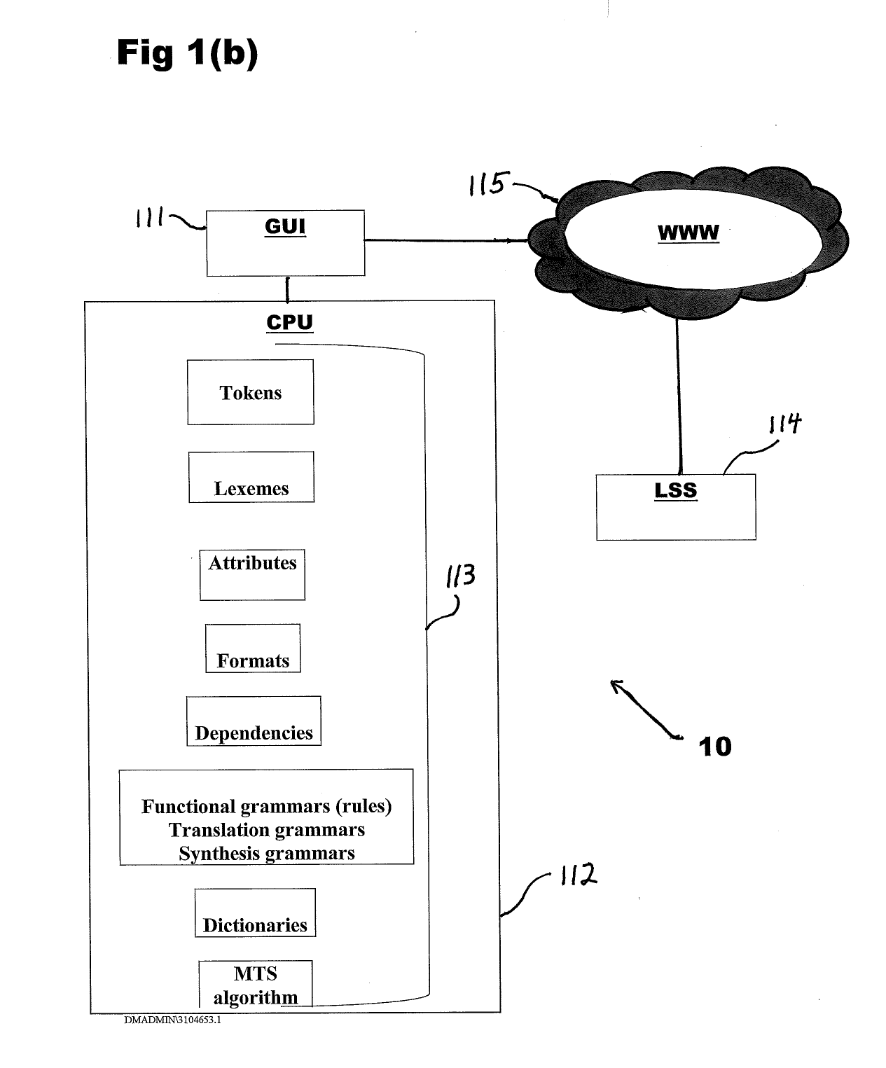

Referring now in more detail to the accompanying drawings and with particular reference to FIG. 1(a) and FIG. 1(b), and as noted above, the machine translation system of the present invention (“MTS”) 10 is a computerized system which translates texts 11 (conveys their meanings) from one natural language to another.

The system includes a graphical user interface (“GUI”) 111 which can be displayed on a typical computer screen and which is coupled to a central processing unit (“CPU”) 112. The CPU 112 contains software 113 for generating and/or recognizing tokens, lexemes, attributes, formats, dependencies, functional grammars, dictionaries and other algorithms of the system, all for performing the process of the invention. Source text 111 to be translated may be entered onto the GUI in appropriate fields and the translation process then initiated by the well-known technique of “clicking” on an appropriate starter button displayed on the GUI. After the process of translation, according to the present invention, is complete, the target language text can then also be displayed on the GUI. The GUI is also coupled to the Internet on the world wide web 115 for accessing the LSS 114.

The method 100 of the invention is modular and structured for organizing languages, which in combination with a transitory (indirect) method of translation allows for the creation of a multilingual system that is capable of translations in any direction between any of included languages.

Every linguistic module includes a dictionary of words and phrases, a list of operational functions, and parameters that guide the conversion processes needed to perform a translation from one language to another. The system further uses an algorithm designed for a machine translation, which is based on a set rules (rule-based).

### The Translation Process

The operating principles of the system of the invention are illustrated in FIG. 1(a) and are described by example of a sample sentence translation. A more detailed description of various system components is provided below. The translation process may be divided into these phases:

(i) Analysis of input text 12

(ii) Direct word-for-word translation 13

(iii) Synthesis of the translated text 14

Analysis 12 determines all parts of speech and establishes the relationships between words. During Translation 13 all words are translated to the output or target language, which are in turn arranged into the appropriate structures in accordance with the grammar and word relationships of the target language. Synthesis 14 performs the final modifications, rearranging the text and adding proper endings. Every step uses a set of rules for text conversion that are incorporated into operational grammars.

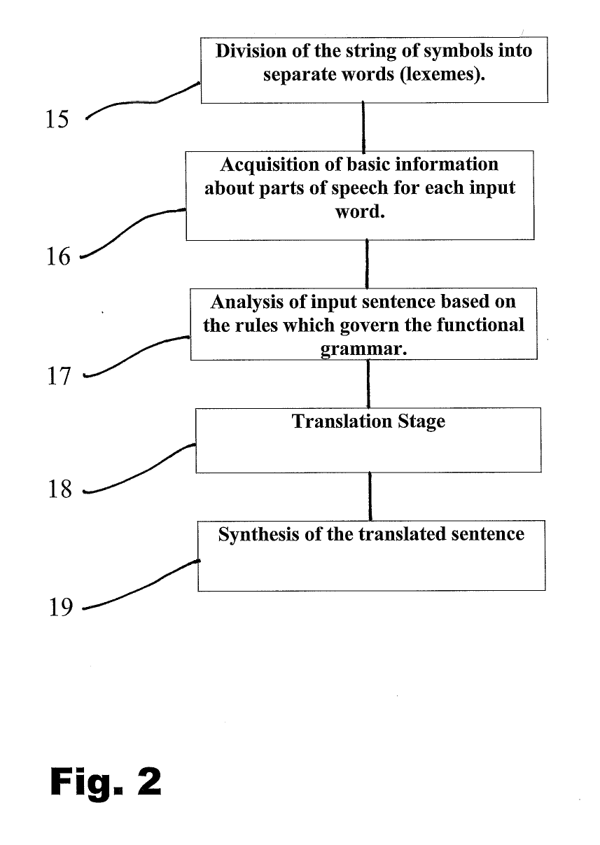

The processing of information in the system is rather similar to the function of the human mind during translation. As illustrated in FIG. 2, a simple sample sentence is translated from English to Russian. (A more thorough description of the translation process will be given in the section below entitled “Functional Algorithm of MTS”).

Input sentence: A girl eats an apple.

First Step 15. Division of the string of symbols into separate words (lexemes)

A
girl
   eats
      an
         apple

Second Step 16. Acquisition of basic information about parts of speech for each input word. This information is taken from the English orthographic dictionary:

A UPPERFIRST
a Sg Art

girl
girl N Sg SCase Anim

eats
eats(eat) V VV Pres Sg ThPson Time Vi

an
an Sg Art

apple
apple N Sg SCase Food Fruit
apple Adj

Here the following values are used:

Art—article

N—noun

V—verb

Adj—adjective

Third Step 17. Analysis of input sentence based on the rules which govern the functional grammar of the English language.

A UPPERFIRST LinkArt.L(girl)
a Sg Art

girl Sub LinkArt.R(A) SubjPred.L(eats)
girl N Sg SCase Anim
eats SubjPred.R(girl) DirObj.L(apple)
eats(eat) V VV Pres Sg ThPson Time Vi

a LinkArt.L(apple)
a Sg Art

apple Sub LinkArt.R(a) DirObj.R(eats)
apple N Sg SCase Food Fruit

The word apple has only one part of speech—noun. This choice is made because of the fact that it follows an article “the”.

The relationships between words are also established. Articles are attached to their corresponding words with the dependency Lin kArt, subject to predicate—SubjPred, verb to direct object—DirObj.

Fourth Step 18. Translation stage—described in translation grammar.

Translation of Words:
girl>>> [symbol]
eat>>> [symbol]
apple>>>

[symbol]

Translation of Dependency:

[symbol] (girl) [symbol] [symbol] ( [symbol] )

[symbol]

[symbol]

[symbol]

[symbol]

[symbol]

[symbol] (eats) [symbol] [symbol] ( [symbol] ) [symbol] ( [symbol] )

[symbol]

[symbol]

[symbol] (apple) [symbol] [symbol] ( [symbol] )

[symbol]

[symbol]

[symbol]

[symbol]

As there are no articles in the Russian language, LinkArt isn't used. The dependency SubjPred is swapped with [symbol] , and DirObj becomes [symbol] ( [symbol] [symbol] [symbol] [symbol] —Direct object in accusative case).

Fifth Step 19. Synthesis of the translated sentence—described by the functional grammar of synthesis.

[symbol] (girl) [symbol] [symbol] ( [symbol] )

[symbol]

[symbol]

[symbol]

[symbol]

[symbol]

[symbol] (eats) [symbol] [symbol] ( [symbol] ) [symbol] ( [symbol] )
[symbol] ( [symbol] )

[symbol]

[symbol]

[symbol]

[symbol]

[symbol] (apple) [symbol] [symbol] ( [symbol] )

[symbol]

[symbol]

[symbol]

[symbol]

In this step change is made to the verb [symbol] eCTb [symbol] —Infinitive becomes the 3rd person form. Cases are also determined, as well as other necessary information.

After synthesis we receive the output sentence in Russian—

[symbol]

[symbol]

[symbol]

After synthesis 19 we have the fully outlined structure of the sentence. This enables the sentence to be easily translated to any other language without the need to repeat the analysis step 19. Transitive translation is based on this principle.

### System Structure

To understand how the machine translation system 10 works, it is necessary to have a good understanding of precisely how each of its structural elements function. System elements include lexemes, attributes, formats, dependencies, and functional grammars.

The structural elements of the system are governed by rules. These rules are written in the internal programming language of the machine translation system. The rules are used to correctly translate each token, sentence, or paragraph from the original language to the target language.

In the following subheadings are descriptions of each of the elements of the MTS, as well as basic information about grammars and rules of analysis, translation, and synthesis.

### Lexemes

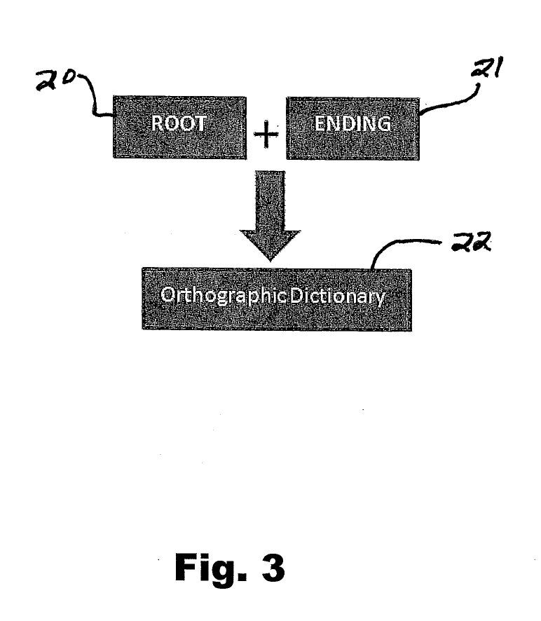

One of the structural elements of the system is the “lexeme” as illustrated in FIG. 3, which is a schematic representation of a lexeme. In order to avoid the need to enter all forms of the lexeme, the MTS divides them into an unchangeable component (“ROOT”) 20, and a changeable part (“ENDING”) 21. Separate categorized endings can be used with various roots to generate lexemes (for example like=>likes, liked).

The concept of a root 20 in the MTS does not coincide with roots in the traditional grammatical sense. In the MTS a root 20 is the smallest unchangeable part of a lexeme. In some languages there may be no roots at all. An example of this is the irregular verb in the English language. In cases where there is no root, the special value * (asterisk) is used.

Endings not only form specific word forms, but also carry information about many characteristics of the word, such as part of speech, number, ending (masculine/feminine/neutral), case, tense, etc.

A positional method is used to classify formats which contain all of the necessary characteristics of a given word form. Here is an example. In English the majority of nouns have different endings in subjective case and possessive case, as well as in singular or plural form. Using the word home we can show these different forms:

home—subjective case, singular;

homes—subjective case, plural;

home's—possessive case, singular;

homes'—possessive case, plural

If we take the unchangeable portion as home, the ending will be as follows:

*—subjective case, singular;

s—subjective case, plural;

's—possessive case, singular;

s'—possessive case, plural

An asterisk marks where an ending is not required.

Here these processes are brought together:

1. Attributes are given for ca [symbol] [symbol] [symbol] [symbol] :

SCase, PCase, Sg, PI

2. The positions of the various elements of the format are sequenced:

Sg&SCase PI&SCase Sg&PCase PI&Pcase

3. The format itself is created and it is given a mnemonic, here NOUN, and all of the attributes are listed in the order shown above:

NOUN (N): Sg&SCase PI&SCase Sg&PCase PI&PCase

4. The format can now be used to describe all words to which it corresponds:

home+NOUN*s ‘s s’

Classification of word forms using this format is relatively simple, but as it is used rather often with various nouns it may be simplified, describing the ending in one mnemonic:

Ns: NOUN: * s ‘s s’

Now all word forms can be classified with the format. For each word form there is an entry in the orthographic dictionary, such as: home+Ns

Other examples—table+Ns, account+Ns, etc.

The mnemonics describing endings, formats, and attributes are determined by the linguist during the creation of a language module and can use the alphabet of that particular language.

In another example of word form description for the Russian language, the example will be the world “AOM”. The word declines into five cases, each with singular and plural forms, in total ten different endings:

Singular: [symbol] , [symbol] , [symbol] , [symbol] ,

[symbol]

Plural: [symbol] , [symbol] , [symbol] , [symbol] ,

[symbol]

Here [symbol] , [symbol] , [symbol] , [symbol] , [symbol] are attributes that correspond to the five cases: nominative, dative, instrumental, prepositional, and genitive. For this word accusative case coincides with nominative, and so it is omitted.

Now the format for the endings is created. As accusative and nominate case have the same endings, we create an intermediate working format. It is called [symbol] ( [symbol] [symbol] [symbol] ).

[symbol] : [symbol] [symbol] [symbol] [symbol] [symbol] .

Now singular and plural forms are joined under the form PM ( [symbol] [symbol] ):

PM: [symbol] ( [symbol] [symbol] ) [symbol] ( [symbol] [symbol] )

In conclusion, the ending is given the mnemonic PMOMa:

PMOMa PM: * y OM e a a aM aM [symbol] ax OB

And we put the following entry into the orthographic dictionary:

[symbol]

In summary, the process of entering a word into the orthographic dictionary is as follows:

1. Attributes are determined which describe all possible characteristics;

2. Formats are given for all necessary endings;

3. A list of mnemonics is created for the endings;

4. Words are entered into the orthographic dictionary as root+description of its ending.

In this manner the process of entering words into the dictionary is greatly simplified, inasmuch as various regular word forms use the same endings.

It's also worth noting that the dictionary has a “cluster” structure and contains two types of entries:

Base lexemes; and

Sub-lexemes

Sub-lexemes are formed in a similar manner as base lexemes, they also have a single root meaning, but they are different parts of speech (or they have a significant variation in attributes), and as such require a different format. Base lexemes are listed as linear entries, and their sub-lexemes are written with an indentation. (For some words several levels of sub-lexemes are possible). Below are described several examples for the English orthographic dictionary:

Cluster
Cluster

adorable+Adj base lexeme
adorably+Adv sub-lexeme
adorableness+Nes sub-lexeme
   Cluster

bad+Adj (IA) base lexeme
badness+NOUNSG * sub-lexeme
badly+Adv sub-lexeme
   worse+Adv (More) sub-lexeme
   worst+Adv (Most) sub-lexeme
bad+Adv sub-lexeme
bad+Ns (Rare) sub-lexeme

In the Russian language we find larger clusters:

### Cluster

[symbol] + [symbol] ( [symbol] ep) base lexeme

[symbol] + [symbol] ( [symbol] ep) sub-lexeme

[symbol] + [symbol] ( [symbol] ep) sub-lexeme

[symbol] + [symbol] sub-lexeme

[symbol] + [symbol] ( [symbol] ep) sub-lexeme

[symbol] + [symbol] ( [symbol] ep) sub-lexeme

[symbol] + [symbol] ( [symbol] ep) sub-lexeme

[symbol] + [symbol] sub-lexeme

[symbol] +Kp ( [symbol] ) sub-lexeme

[symbol] + [symbol] ( [symbol] ep) sub-lexeme

[symbol] + [symbol] ( [symbol] ) sub-lexeme

[symbol] + [symbol] ( [symbol] ) sub-lexeme

[symbol] + [symbol] ( [symbol] ) sub-lexeme

[symbol] +( [symbol] ) sub-lexeme

[symbol] + [symbol] ( [symbol] ) sub-lexeme

[symbol] + [symbol] ( [symbol] ) sub-lexeme

[symbol] + [symbol] ( [symbol] ) sub-lexeme

[symbol] + [symbol] ( [symbol] ) sub-lexeme

Basically a dictionary cluster is a combination of a base lexeme and its sub-lexemes.

Examining the dictionary, we see that some lexemes do not have a root. They are formed by entering endings individually. This method is used for words which have a completely different spelling in each of their forms. (An example of this are irregular English verbs.)

### Cluster

+VERB (: Vi) eat eat eats ate eating eaten

### Cluster

+VERB (Vii DInf Waway Won Wto by Woff Wout Wdown Wover V through Wback Walong Waround Wunder) go go goes went going gone

### Cluster

+SNADJ (IA) good better best base lexeme
   better+Adv (More) sub lexeme
   good+Adv sub lexeme

Therefore it is necessary to understand that division into ROOT and ENDING in the dictionaries of the MT system is solely a lexeme division for processing by the system, and as such does not necessarily correspond to the common linguistic concepts of root and ending.

### Attributes

Attributes determine parts of speech and their possible characteristics and indicators. All attributes are listed in the MTS system's list of attributes.

The list of attributes outlines available word characteristics for a given language (usually parts of speech and other grammatical characteristics), combined into specific groups. Attributes are grouped according to such characteristics as part of speech, person, number, tense, case, and so on. Every group contains a list of names or mnemonics for the corresponding attributes, as well as descriptions and commentary.

The structure of the attribute list is as follows:

Name of group 1

Attribute 1//commentary

Attribute 2//commentary

Attribute 3//commentary

Attribute 4//commentary

Attribute 5//commentary

Name-of group 2

Attribute 1//commentary

Attribute 2//commentary

Attribute 3//commentary

Attribute 4//commentary

Attribute 5//commentary

For example the group PERSON in the list of attributes for English includes three attributes:

PERSON
FPson //first person (I write)
SPson //second person (You write)
ThPson /third person (He writes)

It's assumed that any attribute or combintion of attributes can be assigned to a lexeme or token. Nonetheless, the MTS allows for rules to be created which set the “exclusivity” of attributes within a group of attributes. The rule prevents more than one attribute of a particular group from being used to describe the same lexeme or token simultaneously. For example, one word can't be both verb and noun at the same time in the context of a sentence.

An exception to this rule is a group of attributes known as SYSTEM ATTRIBUTES. This list of attributes is generated by the system for each language and allows for more than one attribute from this group to be assigned to a token or lexeme.

Formats

A “format” is a series of attributes which can be used for:
Description of ending positions;
Creation of a mnemonic for a group of various attributes.

All formats may be found in the list of formats.

Formats are formed using attributes. Here is an example of an entry in the list of formats:

| VMOD2 | (V Time ModV): | VV&Pres | VV&Past |
|---|---|---|---|
| Format | (Attribute/attributes) | Position 1 | Position 2 |
| Mnemonic | | Finite verb & | |
| | | Present indefinite | |

These mnemonics are formats. The second element of a format is a universal attribute for the format that will work for all positions of the format. For example (V Time ModV). Further all positions for the format are listed after a colon: In this example two positions are shown (position 1 and position 2). Each position can contain one attribute or be a combination of various attributes joined by the use of the operator “&” (VV, Pres, Past are attributes).

The first position of any format is ALWAYS a lemma or lexeme.

Attributes can be assigned to lexemes in the dictionary only by endings and their corresponding formats. Endings can be described in the dictionary:
directly; or
by mnemonic.

An example of an attribute given as a mnemonic in the dictionary: play+Vs.

Where Vs was earlier described as an ending.

And here is an example of an attribute given directly in the dictionary:

| play | + | VERB | ** s ed ing ed |
|---|---|---|---|
| root | dependency | Format | List of endings |

Here the format and the list of endings follow directly after the root, instead of the link to Vs in the file of endings.

Its possible the many lexemes don't have their own endings. In this case an asterisk (*) occupies the position of the unused ending(s) in order to assign formats and attributes to the word. For example, if in the system dictionary the word IBM should be marked as the part of speech abbreviation, the next four steps should be taken:

### Step 1:

Add the attribute for abbreviation (Abbr) to the list of attributes (in the group PARTS_OF_SPEECH):

PARTS_OF_SPEECH

Abbr //Abbreviation (IBM)

### Step 2:

Create the format for abbreviation (ABBR) in the list of formats:

ABBR (Abbr): *; //IBM

The format ABBR covers the fundamental characteristics of the attribute with the name Abbr (keep in mind that these names are alphabetized) and occupies only one position. Only the attribute Abbr occupies this sole position.

### Step 3:

Now it's necessary to create an empty ending, which is named Abbr in the list of endings:

Abbr ABBR *; //IBM+ Abbr

Where Abbr (the same mnemonic as the attribute)—is the ending for the ABBR format and contains only one empty position (*).

### Step 4:

Only after all of this is done can an entry be made in orthographic dictionary using the ending Abbr to specify that the word IBM is an abbreviation and does not have an ending: IBM+ Abbr;

It is also possible to join supplemental attributes with lexeme. s in the dictionary for certain situations. For example:

| ar | +VERB | (:Vi) | ise ise ises ose; |
|---|---|---|---|
| Root | Format | Supplemental attribute | List of endings |

Supplemental attributes are added in parenthesis after the format. A colon may be used in the entry of the base lexeme to specify that this supplemental attribute not only applies to the base lexeme, but to also all connected sub-lexemes. Here is an example:

| antique | +Adj | (SV); |
|---|---|---|
| Root | Ending | Supplemental attribute |

### Endings

An “Ending” is the changeable part of a word, which, in combination with a root, forms a lexeme. Endings may be given directly in a list of possible endings or through a format with a corresponding chain of endings. In order to describe word forms which follow a regular pattern of endings it is necessary to use a format, which is a list of attributes for various word forms.

The elements of various word forms can be found in the following lists:
list of attributes;
list of formats;
list of endings;
orthographic dictionary

Possible ending sets are listed in the ending list and have corresponding mnemonics.

Entries in the orthographic dictionary are formed as a combination of root and ending mnemonic, joined with a plus sign “+”. Sample entry for the word play.

| play | + | Vs | (Vii Wdown Wup Wup_to) |
|---|---|---|---|
| Root | Union | Ending mnemonic | Attributes |

Sample entry in the ending list:

| Vs | VERB: | ** s ed ing ed | // comment |
|---|---|---|---|
| Ending mnemonic | Format | Ending positon | Commentary |

Every entry in the ending list has an ending mnemonic, after that follows a format, and then ending position and commentary (optional).* signifies a blank value for the ending (in this position of the format nothing is added to the root of the lexeme). In the given example there are six ending positions. These six positions generate sixlexemes from the dictionary entry play+Vs:
play+*=play
play+*=play
play+s=plays
play+ed=played
play+ing=playing
play+ed=played

This approach allows entry of words in the dictionary to be greatly simplified, as words with regular forms use the same endings.

Endings may be written in the ending list or directly in the dictionary in the form of a link with the operator “=”. Many such examples may be found in the ending list for the Russian language, where some endings are often given through a link to others.

For example, in the ending list for Russian for plural nouns there are two functional endings—p1 and p2. They are recorded in the following manner:
p1 [symbol] // [symbol]
p2 [symbol] // [symbol]
   Where [symbol] , [symbol] , [symbol] are attributes of the dative, instrumental, and prepositional cases respectively.

Other endings for nouns may be entered by making a link to these functional endings:
[symbol] [symbol] M: K [symbol] K=p1 eK // [symbol]
[symbol] [symbol] M: K [symbol] K=p1 OK // [symbol]
[symbol] [symbol] M: [symbol] [symbol] =p2 [symbol] // [symbol]
[symbol] [symbol] M: [symbol] =p2eB //

[symbol]

### Dictionaries

Dictionaries are important components of the system. For each direction of translation there are three:
Orthographic dictionary of the input language;
Orthographic dictionary of the output language;
Translation dictionary from the input language to the result language.

The orthographic dictionary, or orthography, contains the word forms of various words and their attributes which describe various syntactical and semantic characteristics. The translation dictionary establishes correlations between words and phrases in both input and output languages.

### Dependencies

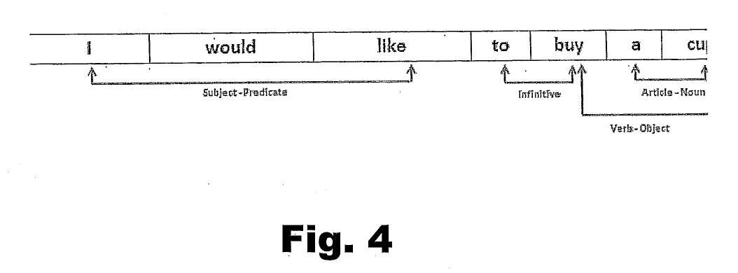

Dependencies are connections or correlations between two words and usually signify the grammatical relationship between these words. An example of a dependency for the English language is shown in FIG. 4.

All dependencies for a particular language can be found in the list of dependencies. Dependencies are set for a specific language, and the system references them during operation. Every dependency is used between only two words, and is composed of three elements:
Name/mnemonic
Parameter for the right-side lexeme in the dependency (in parenthesis)
Parameter for the left-side lexeme in the dependency (in parenthesis)

Dependencies are entered in the following manner:

Name of Dependency (Left Parameter Right Parameter)

### Grammars and Rules

“Grammar” is the set of rules that describe the sequence of conversion of linguistic information during the translation process.

“Rules” are the set of instructions that create the algorithms responsible for processing linguistic information. Rules process a given fragment of text with the objective of translation to another language. Rules are written in the internal programming language of the MTS on single lines. For each language a separate library of rules is created. Using these rules, MTS attempts to categorize sentence structure and determine grammatical dependencies between all words.

The grammar for a particular language may be written only after all of the necessary attributes, formats, endings and dependencies have been created, as well as a sufficient quantity of words having been entered into the orthographic dictionary to allow the system to recognize basic sentences. In the present invention there exists two groups of grammars:
Base
Working

Grammar of analysis, translation grammar, and grammar of synthesis are all base grammars. These grammars work during the processes of analysis, translation, and synthesis.

Working grammars include service grammars, dictionary grammars, and helper grammars. Working grammars are used in the same way as base grammars (in particular helper grammars are used for processing phrases).

The separation of grammars into groups of analysis, translation, and synthesis allow a more logical organization for linguists. The MTS has equal access to all grammars in these groups.

Grammars come into play after a sentence entered into the system has been broken down into a series of tokens and attributes are assigned to these tokens. Each grammar works on the principle of OR, that is a grammar is considered to be active if at least one of the rules in the grammar is validated. Rules are written on the principle of AND—the rule is considered valid if all conditions are met.

Processing of a group of tokens is carried out by grammars according to their order. Each of the tokens is tested by each of the grammars in their order of procession, and then all of the rules which the grammar consists of are implemented in ascending order. If the conditions of a rule are met, then the process starts from the top again. The cycle continues until all rules have been applied. As soon as the conditions of a rule are not met, the process stops. At this point the next token is put through the grammar and the process is repeated. If the last token in the sentence has been processed, the system moves on to the next grammar and begins to process the first token through it, and so on until all tokens have been processed through all of the grammars.

A grammar may work with one or two parameters. The base grammars of analysis, translation, and synthesis work with one parameter, but functional grammars can accept either one or two parameters.

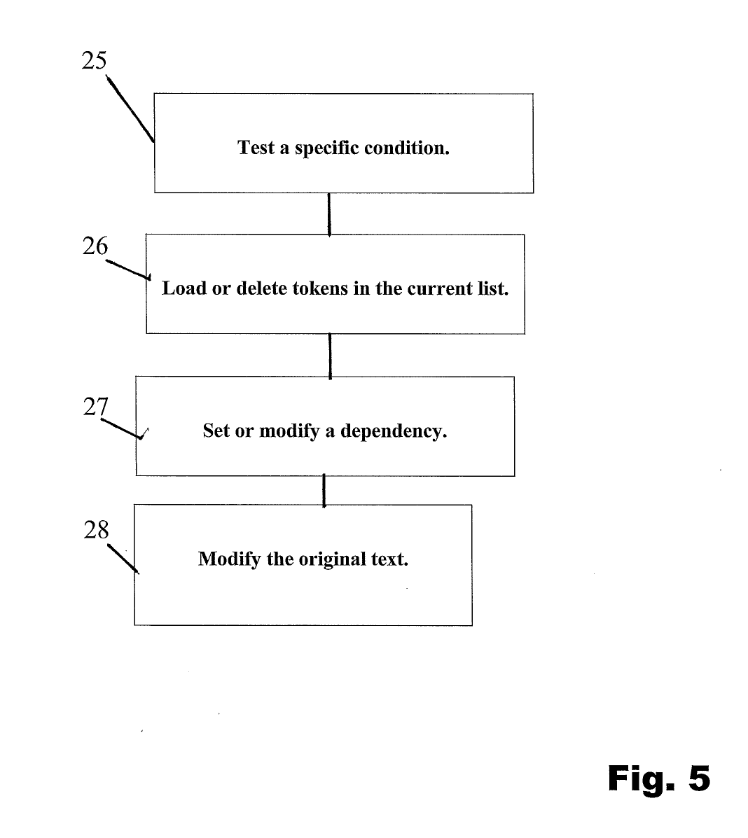

Rules operate with the logic IF/THEN. Rules are executed in the following sequence, as illustrated in the steps of flow chart of FIG. 5:
Test a specific condition 25. (Returns TRUE or FALSE.)
Load or delete tokens in the current list 26. (Returns a resultant series of tokens.)
Set or modify a dependency 27. (Carries out a function, gives a dependency, etc.)
Modify the original text 28. (Simplifies text and/or changes word order.)

### Translation

The term “translation” in the MTS implies three separate processes:
Work in the translation dictionary;
Translation of dependencies and attributes;
Work with phrases.

In the translation dictionary are translations for both separate words and whole phrases. Translation of phrases in the MTS has its own features, depending on the type of phrase.

Special grammars located in the group Translation Grammars are designed for phrase translation, as well as for translation of dependencies and attributes.

The translation dictionary includes a list of entries that contain word-for-word translations (lexeme for lexeme) from one language to another using the following syntax:

[input word]>[output word]

[input word]=[output word]

or

[input phrase]>[output phrase]

[input phrase]=[output phrase]

The symbols = and > indicate the direction of translation: left to right (>) or bidirectional (=).

Here are a few examples of word translations from the English-Russian translation dictionary:

go\V=

[symbol]

go\V #ING>

[symbol]

Examples of phrase translations:

go\V #NP own\Adj way> [symbol] # [symbol] /=

[symbol]

go\V aboard a train>

[symbol]

go\V across=

[symbol]

Special grammars used for translation of dependencies and attributes are located in the group Translation Grammars.

Formats are not translated, as there is no need for this during text translation. Here we examine examples of attribute translation from English to Russian. The attribute for singular is translated by its Russian equivalent:

/Sg>>/$

[symbol]

The right side of the dependency PrepSmth is translated by the Russian dependency

[symbol]

@PrepSmth.R>>@ [symbol] .R(−1)

The English article is translated with an empty place marker for Russian:

/Art>>$=

Phrases are combinations of words that have a different translation when compared to the word for-word translation. The mechanism of phrases used in the MTS allows the conceptual meaning and grammatical relationships between words to be translated from one language to another. Phrases are used in situations where it is impossible to get a correct word-for-word translation, or where a certain context changes the meaning of a word.

Three types of phrases are used in the MTS:
Simple;
Contextual;
Parameter phrases.

### Grammar Operational Algorithm

Definition grammar: “Grammar” is a functional component designed to process linguistic information. It consists of a list of rules, which are executed in order from the top of the list to the bottom. Grammar operates with input linguistic information. If one were to use an analogy with programming languages, it's possible to say that grammar is a function whose algorithm is carried out with the help of rules. The same as a function, grammar has a set of input parameters that input information is subjected to. Grammar may have either one or two input parameters.

With the goal of organization, grammars are divided into groups. There are three basic groups: Analysis grammars, Translation grammars, and Synthesis grammars. There are also working grammars: Service grammars, Dictionary grammars, and Auxiliary grammars.

The system initiates the processing of grammars from the base group. Working grammars are used by the system, and may also be activated from rules of basic grammars and or the translation dictionaries.

Grammars work with a prepared sentence that has been broken down into tokens with established preliminary attributes taken from the orthographic dictionary. As noted above, base grammars include:
Analysis grammars;
Translation grammars;
Synthesis grammars.

These grammars define the fundamental steps of translation:
In the beginning, analysis grammars fully break down a sentence (parts of speech and dependencies between words are set).
Next, translation grammars are implemented which translate the meanings of words, attributes, and dependencies to the output language.
Synthesis grammars complete the process, and the translation is complete.

Base grammars are implemented in the order of from top to bottom. Each grammar is also composed of a set of rules that are implemented from top down.

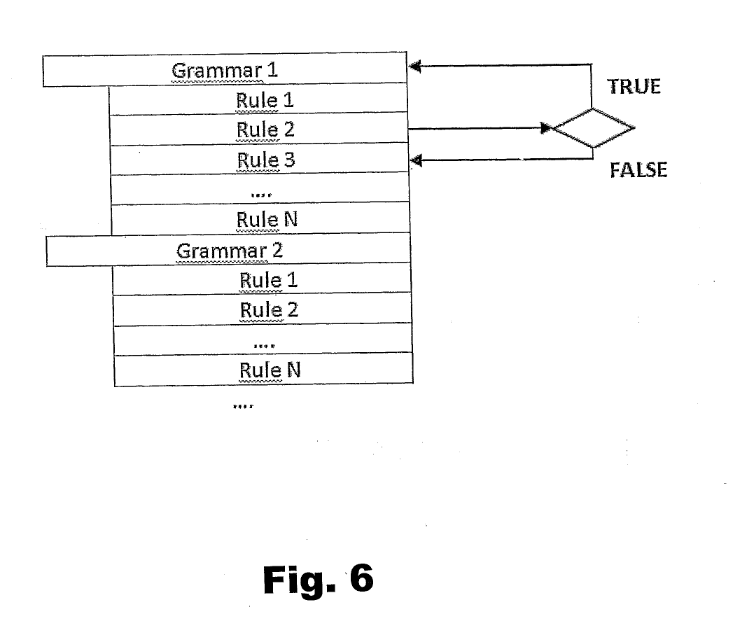

As stated hereinabove, a grammar can accept either one or two parameters. Basic grammars of analysis, translation, and synthesis work with only one parameter. Tokens are loaded into the grammars in the order of from first to last. Using the first token as astarting point the grammar analyses the situation to the left and to the right of this token by checking against the set of rules and makes the necessary modifications as is illustrated in FIG. 6.

During the execution of rules the input text is modified and other rules may be implemented for the new situation, including rules that are higher on the list. In order to not skip these preceding rules, after modification it is necessary to repeat the current grammar again (result TRUE). If the conditions for the rule are not met, then the system moves to the next rule (result FALSE). Attempts to apply rules are made further down the list, and if the last rule returns FALSE the grammar for this example is considered to have been completed. A grammar is considered to be processed if the conditions for none of the rules can be met (they all return FALSE).

After processing the grammar for a given token, the grammar starts on the next token. The input text processing algorithm working with single tokens allows for sentences of any length to be processed using the same set of rules. When the last token in the string has been reached the grammar is considered to be completely processed and the next grammar takes over. This grammar starts again from the first token, and the process is exactly the same as for the previous grammar.

A rule is a sequence of conditions and modifications of the flow list. A rule is considered to be validated if all conditions are met (they are all true). In programming the situation is called joining by condition AND.

A rule is written on one line in a special script language (with the use of operators). A well written rule is considered to contain several different conditions and one modification. Special elements of the statement include the slash (/) and space. These separate the operators of the statement.

During implementation of a grammar its parameters are saved in a “flow list”. The flow list is an internal buffer for storing results of intermediate modifications. Parameters assigned to the grammar are always located at the beginning of the list. Further down the list can be located any necessary tokens that are loaded during processing of the statement. Tokens from the input sentence as well as lexemes directly from the statement may be loaded. When this happens the new element in the list moves to the right and becomes the current one. Any modifications of elements in the flow list lead to changes in the corresponding tokens in the input sentence. Changes are enacted only when the conditions of a statement are fully met (all checks and modifications are true).

As execution of rules are carried out from top to bottom, and if there are a few rules in the grammar whose conditions are met, the rule higher on the list will take precedence. Rules higher on the list have priority over those that are lower. Elements on the flow list are indexed using relative indexing. The last element of the list (the element that was last added to the list) has the index 0 (zero) and is active. Preceding elements are counted back from this element with a minus sign. That is, the element to the left of 0 is −1, the element before −1 is −2, and so on. For example, a list of four elements will be indexed as −3, −2, −1, 0.

The following are examples:

### Example 1

An example of a rule with an operator. X is an empty operator. For any token it returns TRUE. Its main function is to mark the place of irrelevant tokens. For example, if the input sentence is I go. Four tokens enter into grammar analysis (two periods are added to mark beginning and ending points), as follows:

.I go.

In the language for writing rules two kinds of separators are used: slash “I’ and space “ ”. Slash indicates when to process the active token, space means to move on to the next token. If one wants to begin analysis from the first token (period) we use /X. If the first period does not interest us and we want to immediately skip to the second token, we mark the first position with operator X.

Operators for the next positions are written with spaces. For our example the rule:

/X X X X

returns TRUE. But the next rule:

/XXXXX

returns FALSE, because in this example there are four tokens, and in this rule there are five.

Note that these rules are given only as examples. In a real grammar a rule should not only perform a check, but also modify a sentence.

### Example 2

This is an example of a rule with an operator for check/modify. Assume a grammar of SIMPL. For our purposes it only contains one rule: /X V.

Any token may occupy the first position, but in the second position only a word that checks out as a verb (V for verb). In light of this if the word in the second position has several different possible parts of speech, including verb, the verb form will be chosen. All other parts of speech will be ignored.

Thus, the grammar SIMPL works in a step-by-step example using the sentence “I go.”

The word ‘go’ can be two parts of speech—verb and noun. After our rule is applied, only the verb form remains. The input sentence is written like this: . 1 go.

Grammar SIMPL is used for the first token (.). The first token is the parameter for the grammar, and has saved ‘I’ in the flow list:

The first operator of the rule IX is applied to this element and of course returns TRUE. Further on the second operator V comes into play. The space that separates them plays an important role, as it loads the next token into the flow list (1): “.I”

Because “I” is only a noun (not a verb) operator V returns FALSE. The grammar SIMPL has worked and nothing is changed.

The grammar processes the second token again (I). Now the flow list looks like this: The first operator IX is always true, and the second loads the next token (go).

I go

The operator V is activated, eliminating noun as part of speech for go, and returns TRUE. The grammar is launched again for the same token (I). But since there are no modifications, the grammar stops there and the third and fourth tokens are fed in, which return FALSE. In this way the grammar SIMPL has been executed for all input tokens and the system can switch over to the next grammars. As a result of this grammar unneeded parts of speech were eliminated.

This rule has been given here as an example and in real grammars it isn't used. It is so simple and direct that it always eliminates all parts of speech, leaving only a verb. If there is a more complicated sentence, for example ‘I go home’, where the word ‘home’ can be any of four parts of speech (verb, noun, adjective, and adverb), our rule SIMPL will only choose verb, and this will be incorrect. Therefore in real grammars rules are much more complicated and carry out many more checks before making modifications.

### MTS Algorithm

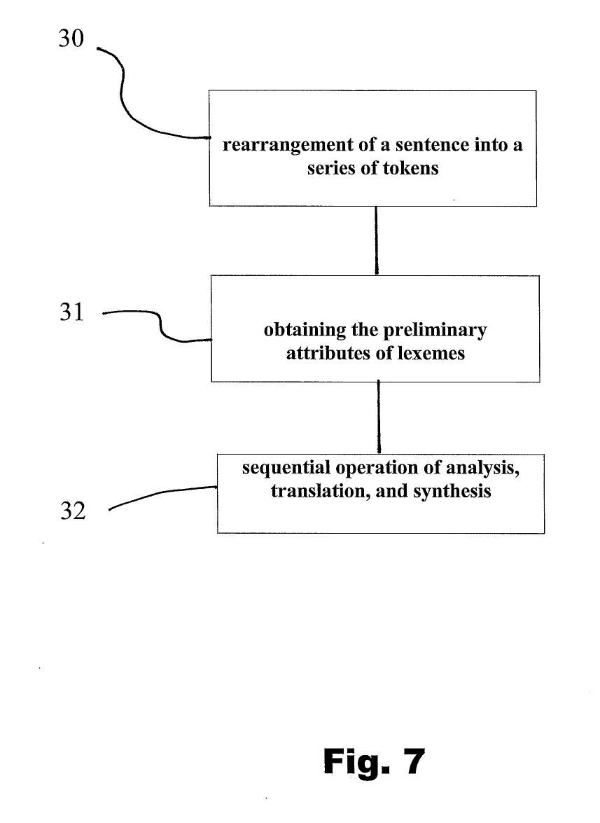

As illustrated in FIG. 7, the functional algorithm of the present invention includes the following basic steps:

The first step 30 is the rearrangement of a sentence into a series of tokens. In this step, the input sentence, being a series of symbols, is converted into a chain of elements that are divided by a space, tab, or line feed character. Such elements are then called tokens. These elements cannot be called lexemes, because the term token is broader and may include any symbols that cannot be translated. A token can be a lexeme, number, date, url, punctuation mark, and in general any chain of symbols.

The second step 31 is obtaining the preliminary attributes of lexemes. For tokens which have been identified as lexemes a search is carried out in the orthographic dictionary. If a corresponding word is found all versions of the word are loaded with their primary attributes. Attributes are identifiers of any characteristic of a word, for example part of speech, as well as semantic characteristics and system attributes.

If a word is not found in the dictionary, it is given the system attribute NOTFOUND. System attributes are located in the list of attributes in the group System (or [symbol] ).

The third step 32 is a sequential operation of analysis, translation, and synthesis. Conversions are carried out using grammars which are organized as follows:
Base grammars:
   Analysis grammars;
   Translation grammars;
   Synthesis grammars;
Working grammars:
   Service.grammars;
   Dictionary grammars;
   Auxiliary grammars

The system works in the following manner Grammars process a series of tokens. A grammar is a list of rules that are applied in order from the top of the list to the bottom. If a rule is successfully applied, the grammar starts again from the top until a rule is encountered that doesn't return TRUE. When this happens, the grammar stops processing the token, and the next token is processed. If this was the last token in the string, the system switches to the next grammar and starts over again with the first token. The result of this process is a finished translation.

### Operation of MTS

In the following paragraphs, a more detailed description of the operation of the MTS is provided using the sample sentence: “I go to the USA on Jan. 1, 2014.”

The text translation sequence is carried out step-by-step by the various elements or blocks of the MTS as described and illustrated herein. Although previously discussed, these steps and elements will be described more thoroughly in the following paragraphs.

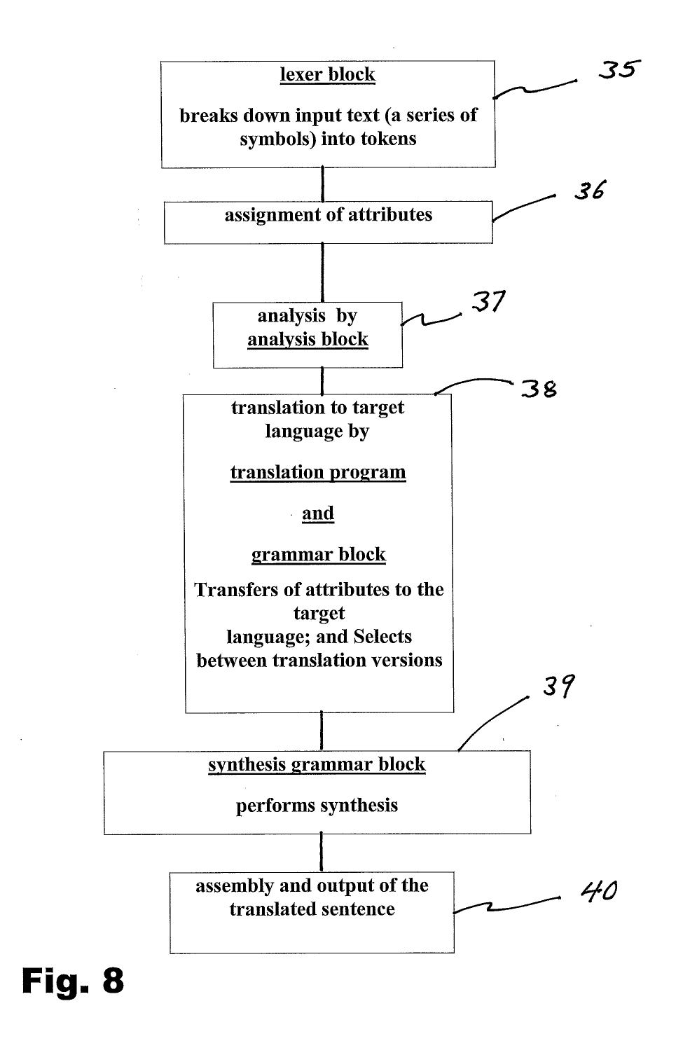

As illustrated in FIG. 8, a first step 35 is the division into tokens. A first block of the MTS is the lexer, which breaks down input text (a series of symbols) into tokens. Tokens are separated by spaces punctuation marks, line ends, and the beginning and end of the text. According to the results of analysis of individual symbols system attributes (from the group System) are assigned to tokens, for example for all caps UPPERALL, for first letter capitalized UPPERFIRST, and others. Sentences may be divided based on punctuation. The limits of a sentence are set by period, semicolon, colon, and question/exclamation marks. Text enclosed in parenthesis is examined as a separate sentence which is inserted into another sentence, but stands separately. Text in parenthesis is translated first. Translation is carried out by sentences.

The second step 36 is the assignment of attributes. Every word belonging to a sentence that is to be translated is searched for in the dictionary. The search looks for all grammatical variants of the word. These variants are made up of sets of base and additional base attributes for the word.

For example, a word form for the Russian word [symbol] is encountered in a sentence. According to the orthographic dictionary there are a few possible alternatives:

[symbol]

[symbol] ( [symbol] ) [symbol] Φ2

[symbol] ( [symbol] )

[symbol]

[symbol]

[symbol]

[symbol]

[symbol] ( [symbol] )

[symbol]

[symbol]

[symbol]

[symbol]

[symbol]

[symbol] ( [symbol] )

[symbol]

[symbol]

[symbol]

[symbol]

[symbol]

[symbol] ( [symbol] )

[symbol]

[symbol]

[symbol]

[symbol]

[symbol]

[symbol] ( [symbol] )

[symbol]

[symbol]

[symbol]

[symbol]

[symbol]

These alternatives correspond with the following parts of speech:
Superlative adverb from the word [symbol] ;
Imperative from the verb [symbol] ;
Adjective in 4 different cases from the word [symbol] .

In all, there are six possible alternatives for one word form.

If the given word form is not found in the orthographic dictionary, the token is assigned the attribute NOTFOUND.

The third step 37 is the analysis. The set of word forms that forms a sentence in the input language, including attributes assigned in the previous step, is input into the analysis block. Starting from this step any further processing of linguistic information is performed by grammars. In the grammar analysis block the following operations can take place:
Check of word forms and words in the sentence, and their attributes;
Assignment and addition of word attributes (added attributes are usually secondary or general;
Setting and eliminating words and word forms;
Elimination of unsuitable attributes for word forms;
Setting, checking, and eliminating dependencies between word forms in a sentence.

Otrhographic attributes (or primary attributes) are taken from the orthographic dictionary and are not changeable. General attributes (or secondary attributes) are assigned during lexical analysis and may be changed, deleted, or added to during processing in grammar. The name of this attribute comes from the fact that it is the same for all forms of the word it has been assigned to in the orthography.

After processing in the analysis block any ambiguities in the meaning of words should have been eliminated, all necessary attributes should have been added, and all dependencies between words should have been established (for example subject-predicate, verb-object, and so on).

The fourth step 39 is the translation to the target language. Control is taken over by the system's translation program, which, taking into account the attributes assigned during the analysis process, translates words and phrases from the input language into the target language. The translation dictionary with the corresponding theme is used for this, in which are located word translations and various phrases. Identification and translation of phrases using the attributes and dependencies established in analysis is an important part of translation. Translation begins with a search of phrases, beginning with the longest phrases and finishing with separate words. Translation is regulated with specialized dictionary rules.

Next the translation grammar block for translation from input language to target language takes over. Here the following operations can be carried out:
Transfer of attributes and dependencies from the input language to the target language;
Selection between translation versions that are used in a wide variety of typical situations (for example prepositions, verb complexes, and so on).

The fifth step 39 is synthesis. The synthesis grammar block works during this step. The translated sentence and any components should be completely assembled. As the synthesis block is exclusive to the output language, all operations carried out by this block are not influenced at all by the input language.

The final stage 40 of the translation operation is assembly and output of the translated sentence in according with information received from the synthesis block. This information can be in the form of words, their positions, and internal attributes.

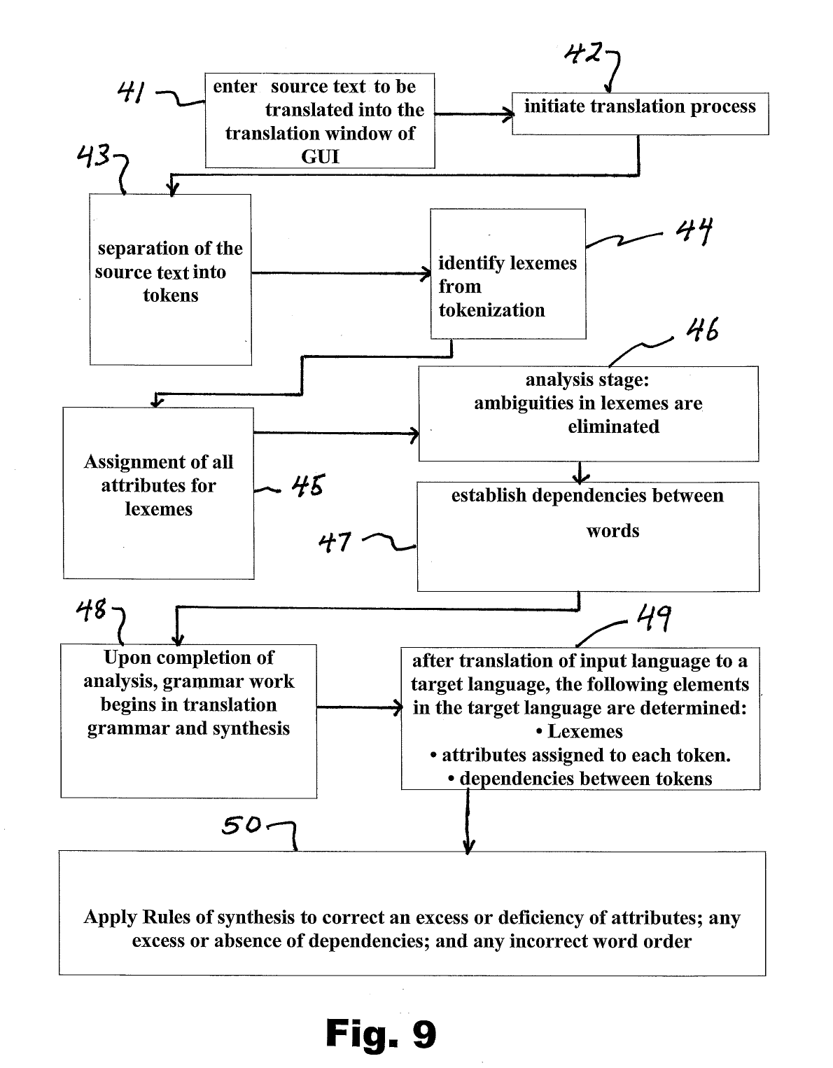

To explain how the algorithm of the MTS works, the example of translating into Russian this sentence will be used in conjunction with FIG. 9: “I go to the USA on Jan. 1, 2014.” As an aid to this explanation, fragments of a trace from the Linguistic Support System (“LSS”) will be used. The trace automatically appears on a screen coupled to the computer after entering the sentence at step 41 to be translated into the translation window and pressing the Translate button to initiate the process at step 42.

The next step 43 is the tokenization of the input text. After separation of a sentence into tokens we have the following list for our English sentence to be translated:

01.

02 I UPPERFIRST

03 go

04 to

05 the

06 USA UPPERALL

07 on

8 Jan UPPERFIRST

09 1st NUMBERORD

10,

11 2014 NUMBER YEAR

12.

Note that both beginning and end of the token string are marked by periods. This is an important detail, because the period at the beginning marks the beginning of the sentence and the period (or other punctuation mark) at the end of the sentence marks the end. The periods are necessary for proper operation of grammar rules.

In the trace it can be seen that some tokens have general attributes:
UPPERFIRST-word begins with a capital letter;
UPPERALL—the word is written in all caps;
NUMBERORD—ordinal number;
NUMBER_YEAR—number year.

These attributes are assigned based on lexical analysis of the text. For deeper grammatical analysis additional attributes are needed, as these alone may be insufficient.

Step 44 is the identification of lexemes from the tokenization step, and step 45 is the assignment of all attributes for lexemes. Tokens from 02 to 09 in this example are lexemes and as such may be assigned ortho-attributes. A search in the othrography is conducted for each of these lexemes, and if one is not found in the orthographic dictionary (due to a spelling error or absence in the dictionary) it is assigned the attribute NOTFOUND.

In our example all of the words are written correctly, therefore we get the following trace:

I UPPERFIRST

I Anim FPson Sg PnP PnWOCase SCase

go

go N Sg SCase Rare
go V VV Inf Vii DInf Waway Won Wto Wby Woff Wout

Wdown Wover Wthrough Wback ...

go(go) V VV Pres Pl Time Vii DInf Waway Won Wto

Wby Woff Wout Wdown Wover ...

to

to Pr
to PrInf

the

the Art

USA UPPERALL

USA N Pl SCase ArtThe Name CityCountry

on

on Adj Norm Rare
on Pr SV

Jan UPPERFIRST

Jan N Sg SCase AName Anim
Jan N Sg SCase Mon

1st NUMBERORD

9st Adj Norm OrdNum

,
2014 NUMBER_YEAR

9 NUMBER

.

Here all of the words are shown as they are found in the orthography.

For the input word “I” the orthography gives:

I Anim FPson Sq PnP PnWOCase Scase

These attributes indicate that the word is an animate pronoun, in first person, singular, and in the subjective case.

The word ‘go’ has only more than one meaning. It has three alternatives—noun (attribute N), and 2 verb forms—infinitive (lnf) and present (Pres). Her are the attributes for the word “Jan”.

| | |
|---|---|
| Jan UPPERFIRST | // general attributes |

| | |
|---|---|
| Jan N Sg SCase AName Anim | // ortho-attributes(name) |
| Jan N Sg SCase Mon | // ortho-attributes(January) |

There is excess information here. A few words have multiple meanings, so at this point an unambiguous translation is impossible.

At step 46 the process of analysis grammar takes place.

In the analysis stage any ambiguities in lexemes should be eliminated, and every word should correspond to only one part of speech. Its also necessary at step 47 to establish dependencies between words.

The analysis grammar PREP ROC will be processed 12 times for each token, including the first and last periods, as follows

1) PREPROC (.)

2) PREPROC (I)

3) PREP ROC (go)

4) PREP ROC (to)

5) PREPROC (the)

6) PREPROC (USA)

7) PREP ROC (on)

8) PREPROC (Jan)

9) PREP ROC (1st)

10) PREP ROC (,)

11) PREPROC (2014)

12) PREPROC (.)

During this process not one rule was applied.

After this, the second grammar DISCONCAT is processed. Here also no rules have been applied.

Further on the grammar PREAUTO eliminated the unnecessary alternative forms of the words on, Jan.

During the process of the grammar PREAUTO, some rules were successfully applied, and the grammar was processed again for the word ‘on’. The grammar will be activated repeatedly until not one rule in the grammar can be executed. A rule is considered validated if all of the rule's conditions are met and the lexeme is modified. After this, the grammar REM RARE begins to work. It leaves only the attributes of the word go which correspond to verb forms (the attribute for noun has been eliminated).

Note that after analysis grammar has worked the example now has the following trace:

AFTER GRAMANALYSIS:
I UPPERFIRST. (R) SubjPred.L(go)
   I Anim FPson Sg PnP PnWOCase SCase
go (R) SubjPred.R(I) VerbExt.L(to)
   go(go) V VV Pres P1 Time Vii DInf Waway Wto Wby Woff Wont Wdown Wover

Wthrough Wforward Whack Walong Waround Wunder Won_Vi
to (R) PrepSmth.L(USA) VerbExt.R(go)
   to Pr
the (R) LinkArt.L(USA)
   the Art
USA UPPERALL Sub (R) LinkArt.R(the) PrepSmth.R(to)
   USA N Pl SCase ArtThe CityCountry Name
on (R) PrepSmth.L(Jan)
   on Pr SV
Jan UPPERFIRST Sub (R) LinkName.L(1st) PrepSmth.R(on)
   Jan N Sg SCase Mon
1st (R) LinkName.R(Jan)
   9st Adj Norm OrdNum
,
2014 NUMBER_YEAR Sub
   9 NUMBER
.

As result of analysis parts of speech have been established, some lexemes have been assigned additional attributes, and dependencies have been established between lexemes: subject-predicate (SubjPred), article-noun (LinkArt), preposition-noun (PrepSmth), and dependency LinkName between 1St and Jan.

Upon completion of analysis grammar work begins in translation grammar and synthesis, step 48. The operating principles for translation and synthesis grammars are similar to those of analysis grammar.

Translation grammar helps with translation of word meaning, attributes, and dependencies to the target language. The result of translation from an input language to a target language are the following elements at ste 49:
Lexemes in the target language (standardized/without inflection).
A list of attributes in the target language assigned to each token.
A list of dependencies between tokens in the target language.

Usually, as result of translation, tokens in the target language have such flaws:
An excess or deficit of attributes (this interferes with declension of the word in the target language);
An excess or absence of dependencies;
Incorrect word order.

The goal of synthesis is to correct all of these problems with the help of rules, using a process analogous to the analysis process. See step 50. All rules of synthesis from the input language to the target language are grouped into the grammars of synthesis.

Note that synthesis rules in linguistic pairs cannot be used in reverse. For example, synthesis rules for English>Russian are different than the rules for Russian>English and do not fully correspond. Similarly synthesis rules for English>Russian are different from rules for German>Russian, and so on.

### Indirect Translation

Indirect translation is a translation method that uses translation through one or more intermediate languages between input and target languages. For transit languages morphological synthesis is absent, and the completely analyzed (marked) sentence is relayed for the next translation.

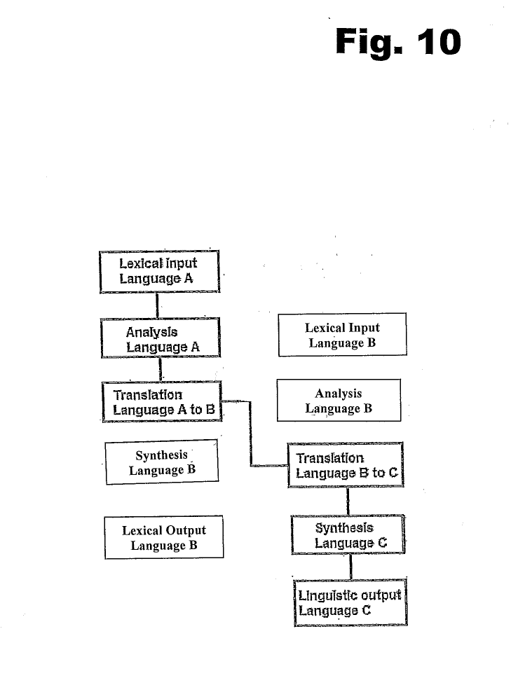

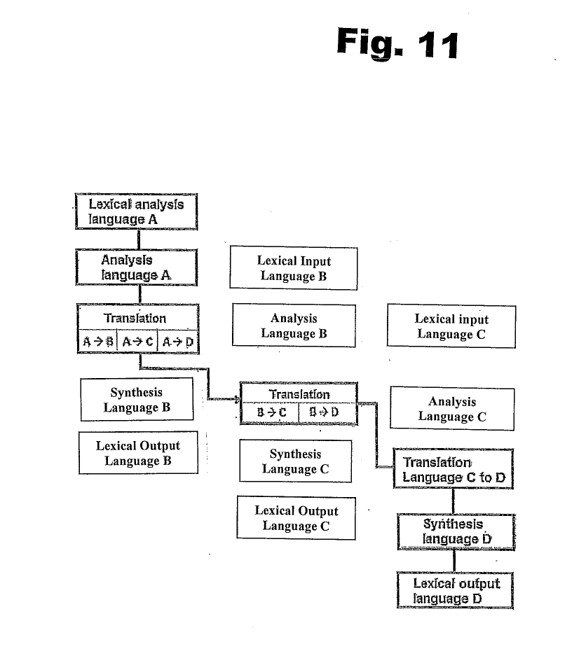

FIG. 10 and FIG. 11 show the steps which the system takes during translation of a language A to a language C and from language A to a language D. The grey tone dotted lines in FIGS. 10 and 11 divide the steps which are skipped during indirect translation.

As seen in FIG. 10, there is no analysis for language B, the results of analysis for language A being used instead. Analysis is the most complex and error-prone process of the translation system. Using this method it is possible to significantly increase the efficiency and accuracy of the system, using analysis for the first stage and not repeating it for each of subsequent translations.

Elements created for step A-B:

1. Lemmas and tokens in language B

2. Assignment of missing attributes

3. Assignment of missing dependencies

For step B-C it is only necessary to do the following:

1. Translation of lemmas and tokens for 8-C.

2. Conversion of attributes

3. Conversion of dependencies

The same logic applies for the situation in FIG. 11, which show the steps for translation for language A to language D. Indirect translation can be successfully employed in the construction of multilingual translation systems.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed is:

1. A machine or computer translation system for translation of a source text conveying its meaning from one natural language to another, comprising software with a modular structure for organizing languages, and a transitory system of translation thereby allowing for the creation of a multilingual system that is capable of translations in any direction between any of included languages, said modular structure including a linguistic module of a dictionary of words and phrases, a linguistic module of a list of operational functions, and parameters that guide a conversion processes needed to perform a translation from one language to another, and an algorithm designed for a rule-based machine or computer translation.

2. The system according to claim 1 further comprising a computer screen for displaying a graphical user interface (GUI), a central processing unit (CPU) coupled with said GUI, and software maintained on said CPU for effecting analysis of said source text for identification of all parts of said text and dependencies between words of said text, and for effecting translation of said source text into a target language text and for displaying said target language text on said GUI.

3. The system according to claim 1 further comprising means for performing synthesis of said translated text.

4. The system according to claim 1, wherein said algorithm is based on grammar and rules.

5. The system according to claim 4, wherein said grammar is a functional block that transforms linguistic information and includes a of list of rules, which are performed consecutively, from top to bottom.

6. The system according to claim 5, wherein grammar rules, comprise a sequence of operators.

7. The system according to claim 5, further comprising a translation dictionary which includes translation of words and phrases from one language to another.

8. The system according to claim 7, wherein said translation dictionary includes consecutive entries, which contain word-by-word translation one lexical unit after another, from one language into another.

9. The system according to claim 8, wherein said translation dictionary includes translations of phrases from one language to another.

10. The system according to claim 9, wherein said translation dictionary operates with special parameterized phrases, which enables formation of translation patterns for similar source texts.

11. The system according to claim 10, wherein each parameter corresponds to a dedicated grammar which checks the correctness of word or word combination placement into a given phrase.

12. The system according to claim 5, further comprising a Linguistic Support System (“LSS”) carried on a remote server and accessible by a browser through the world wide web.

13. The system according to claim 12, wherein said LSS allows linguists and translators to monitor the translation process, edit dictionaries, add translations of language pairs and ensure learnability of the system.

14. A method for translation of a source text conveying its meaning from one natural language to another natural language and into a translated text, comprising analyzing said source text; translating the source text into a translated text; and synthesizing the translated text.

15. The method according to claim 14, wherein said step of analyzing said source text results in an unambiguous identification of all parts of speech.

16. The method according to claim 15, wherein said step of analyzing said source text further results in a set of grammatical relations between two words within said source text known as dependencies.

17. The method according to claim 16, wherein said step of translating comprises word meanings being translated into a target language, and the position of words change in accordance with the grammar of the target language, and said dependencies become transformed.

18. The method according to claim 17, wherein said step of synthesizing includes replacement and insertion of service words, and adjustment of endings.

19. The method according to claim 18, further comprising applying rules of text transformation, which are consolidated into grammars for each of said steps of analyzing said source text; translating the source text into a translated text; and synthesizing.

20. The method according to claim 19, wherein said step of synthesizing results in a fully tagged structure of text in the target language without analysis.

21. The method according to claim 20, wherein said synthesizing into a fully tagged structure of text in the target language without analysis is a transit translation.

22. A method for translation of a source text conveying its meaning from one natural language to another natural language and into a translated text, comprising entering said source text to be translated into a field of a GUI coupled to software on a CPU, initiating the translation process, separating said source text into tokens, identifying lexemes from the tokenization step; assigning attributes to said lexemes, analyzing said lexemes, eliminating ambiguities of said lexemes, establishing dependencies between words, applying translation grammar and synthesis grammar to the translated text in order to determine if in the translated text there are: lexemes; attributes assigned to each token; and dependencies between tokens, applying rules of synthesis to correct any excess or deficiency of the attributes in said translated text and any excess or absence of dependencies in said translated text, and correcting any word order in the translated text.

23. The method according to claim 22, wherein a token is an element that represents a sequence of symbols grouped by predefined characteristics, such as an identifier, a number, a punctuation mark, date, or word, each tokens within a source text being separated by a space, so that all elements located between spaces are identified as separate tokens.

24. The method according to claim 23, further comprising applying an algorithm based on grammar and rules.

25. The method according to claim 24, wherein said grammar is a functional block that transforms linguistic information and includes of a list of rules, which are performed consecutively, from top to bottom.

26. The method according to claim 25, wherein grammar rules, comprise a sequence of operators.

27. The method according to claim 26, wherein grammars work with incoming linguistic information, divided into tokens with defined initial attributes that are obtained from an orthographical dictionary.

28. The method according to claim 27, wherein grammar has input parameters, through which information is received.

29. The method according to claim 28, wherein real values of parameters are provided to grammar input.

30. The method according to claim 29, wherein said values are stored in a current list, said current list being an internal buffer for storing results of intermediate modifications.

31. The method according to claim 30, wherein operators produce changes in current lists, said changes include adding or removing tokens, removing word variations, adding or removing attributes and dependencies.

32. The method according to claim 31, wherein said changes of current lists are made on sentence images and are transferred to said sentence itself only if a main grammar is triggered.

33. The method according to claim 32, If the grammar did not trigger, wherein the image of sentence with changes is deleted and the initial sentence remains in the form it was after last being processed by grammar when said main grammar is not triggered.

34. The method according to claim 33, wherein all changes in the sentence become irreversible after the main grammar is triggered.

35. The method according to claim 34, wherein there are three groups of grammars.

36. The method according to claim 35, wherein said three groups of grammars are a grammar of analysis, a grammar of translation; and a grammar of synthesis.

37. The method according to claim 36, further comprising operational grammars including a grammar of service, a grammar of dictionary; and a grammar of assistant.

38. The method according to claim 37, Further comprising using a dedicated orthographical dictionary which contain words with all distinctive attributes.

39. The method according to claim 38, wherein said dictionary is structured in families with indication of all possible variations of use of a word without translation.

40. The method according to claim 39, wherein said translation process includes translation of words and phrases contained in a translation dictionary.

41. The method according to claim 40, wherein said translation dictionary includes consecutive entries, which contain word-by-word translation one lexical unit after another, from one language into another.

42. The method according to claim 41, further comprising translations of phrases included in said translation dictionary.

43. The method according to claim 42, further comprising transforming the meaning of a phrase and grammatical dependencies between words from one language into another.

44. The method according to claim 43, wherein said translation dictionary operates with special parameterized phrases, which enables formation of translation patterns for a wide array of similar source texts.

45. The method according to claim 44, wherein each parameter corresponds to a dedicated grammar, which checks the correctness of word or word combination placement into a given phrase.

46. The method according to claim 45, wherein placement parameters in phrases are filtered by conditions set by attributes.

47. The method according to claim 46, wherein attributes can be added to a phrase for correct processing of all word forms of a given word.

48. The method according to claim 47, wherein parameters will check for specific value use if the goal is to have the phrase applicable to a wider context.

49. The method according to claim 47, further comprising obtaining words that are absent in the orthographical dictionary during the process of word formation for complex words and words with prefixes and postfixes.

50. The method according to claim 14, further comprising accessing a Linguistic Support System (“LSS”) carried on a remote server accessible by a browser through the world wide web.

51. The method according to claim 50, wherein accessing said LSS allows linguists and translators to monitor the translation process, edit dictionaries, add translations of language pairs and ensure learnability of the system.

52. The method according to claim 22, further comprising accessing a Linguistic Support System (“LSS”) carried on a remote server accessible by a browser through the world wide web.

53. The method according to claim 52, wherein accessing said LSS allows linguists and translators to monitor the translation process, edit dictionaries, add translations of language pairs and ensure learnability of the system.
